(19) United States
(12) Patent Application Publication
(10) Pub. No.: US 2026/0118830 A1
(43) Pub. Date: Apr. 30, 2026

(54) IN-EAR MONITOR WITH INTEGRATED HAPTIC METRONOME

(71) Applicant: Sound Devices, LLC, Reedsburg, WI (US)

(72) Inventors: Matthew G. Anderson, Madison, WI (US); Steven Popovich, Little Chute, WI (US); Christopher Mittlesteadt, Reedsburg, WI (US)

(73) Assignee: Sound Devices, LLC, Reedsburg, WI (US)

(21) Appl. No.: 19/371,473

(22) Filed: Oct. 28, 2025

Related U.S. Application Data
(60) Provisional application No. 63/712,774, filed on Oct. 28, 2024.

(51) Int. Cl. G04F 5/02; H04R 1/10; H04R 5/033; H04S 3/00

(52) U.S. Cl. CPC G04F 5/025; H04R 1/1016; H04R 1/1041; H04R 1/1075; H04R 5/033; H04S 3/008; H04R 2420/07; H04S 2400/01

(57) ABSTRACT

An in-ear monitor system has earpieces with haptic metronome actuators. Synchronized metronome vibration pulses, which pose no audible interference to audio monitoring, stimulate the user's ear and or ear canal. A sound engineer or technician from a control console selects or programs the synchronized metronome timing sequence and the sequence is multicast to one or more receiver body packs worn by the performer in the group. The timing sequence can alternatively be selected in response to audio commands spoken by a user wearing the in-ear monitor, or can be based on a beat sensor.

### CROSS-REFERENCE TO RELATED APPLICATION

The present application claims priority to U.S. Provisional Patent Application No. 63/712,774, filed Oct. 28, 2024, the content of which is incorporated herein by reference in its entirety.

### FIELD OF THE INVENTION

The invention pertains to an audio in-ear monitor with a haptic metronome, which is particularly useful for musicians in loud environments. The invention improves the ability to perceive a silent synchronizing metronome vibration pulse that does not interfere with audio perceived via an in-ear monitor.

### BACKGROUND

A metronome is a device that normally produces an audible click or other sound at a uniform interval that can be set by the user, typically in beats per minute (BPM). Metronomes sometimes also include synchronized visual motion, such as blinking light, or haptic signals like vibrations. Musicians often practice with a metronome to improve their timing, and sometimes musicians use a metronome during performances as well.

It is known to transmit metronome click tracks with audio cues to in-ear monitors to assist performers with timing. Some musicians prefer however to use haptic or tactile metronomes such as the haptic metronomes disclosed in U.S. Patent Application Publication No 2017/0285578 entitled “Tactile Metronome” by Julian Vogels et al., published Oct. 5, 2017 and U.S. Pat. No. 7,268,290 entitled “Tactile Metronome” by Christopher Parsons, issuing Sep. 11, 2007. Both of these patent references describe systems that provide tactile stimulations with a beat pattern so that the performer can synchronize to the tempo of the beat pattern. The Vogels et al. '578 publication discloses a vibration generator in the form of an eccentric rotating mass which is adapted to be attached to a strap or band and worn by the user on the wrist, arm or chest. This haptic metronome is configured to communicate with a smartphone e.g., via Bluetooth®. Software on the smartphone is able to control the BPM and is also able to connect to multiple haptic metronomes so that all band members can receive and feel the same, synchronized BPM. One of the advantages of haptic metronomes is that they do not interfere with the audio stream transmitted to the in-ear monitor.

Professional stage in-ear monitor systems typically use wireless technology to send the audio mix to the in-ear monitors. The system typically transmits audio data from a control console via a transmitter (transceiver) to a receiver (transceiver) in an audio base unit (receiver body pack) worn by the performer. Any number of receivers can receive a single audio mix. The transmitters and receivers transfer audio wirelessly via a tuned radio frequency (e.g., tunable in VIHF and UHF). The in-ear-monitor cable typically plugs into a 3.5 mm stereo jack on the receiver pack (audio base unit), which is typically clipped onto the belt, guitar strap, clothing of the performer, or placed in a pocket. The receiver pack outputs analog audio signals to the in-ear monitors which are the last stage of the signal path in the system. The in-ear monitors are placed in the external ear canal and seal against the sides of the ear canal. Universal in-ear monitors typically include a variety of foam and silicone tips. If a universal earpiece does not fit a specific person, they may need to order custom in-ear monitors. Custom molded in-ear monitors are more comfortable to wear and better isolate ambient noise but can be quite expensive. Depending on the quality of the fit and length of the canal portion of the earpiece, a custom fit in-ear monitor will generally provide somewhere between 25 and 34 dB of noise reduction. This means that loud onstage instruments are less likely to cause hearing damage for onstage musicians wearing in-ear monitors. Impressions for custom in-ear monitors are often taken by an audiologist.

Some performers desire a more natural sound from their in-ear monitors. Passive ambient in-ear monitors have a small hole drilled into the earpiece to allow some natural ambient sound into the ear canal. This can potentially lead to increased sound exposure as it reduces the signal-to-noise ratio for the audio mix and causes the musician to increase the volume of the in-ear monitor. Active ambient in-ear monitors use external microphones to reproduce the ambient sound in the audio mix.

Many modern audio systems have multiple acoustic output transducers (often times referred to as “speakers”) that work collectively in order to efficiently convert electrical information to a physical waveform that is clearly perceived (heard) by a user (listener). For example, miniaturized headphones and even earbuds often rely on multiple acoustic output transducers, where a smaller transducer (speaker) provides more effective sound reproduction at higher frequencies and a larger transducer (speaker) provides effective sound reproduction at lower frequency sounds in the ear canal of a listener. An example prior art application of this technique is presented by U.S. Pat. No. 8,311,259 where an earphone (or earbud) is configured to fit within a user's auditory canal and contains multiple balanced armature transducers connected to the output of a frequency divider network (labelled as item 107 in FIGS. 1 through 4 of the '259 patent). Some challenges posed by this approach include the need to house a frequency divider network and the fact that if implemented in hardware, it may be difficult (or impossible) to reconfigure based on the customized preferences of a user while in operation.

Hearing fatigue and risk of hearing loss are important considerations with the design and use of in-ear monitors. For example, U.S. Pat. No. 10,667,067 B2 entitled “Earguard Monitoring System” by Steven Wayne Goldstein, issuing May 26, 2020, describes a monitoring system for the loudness effects with an in-ear transducer. An alert is provided if risk is present for either hearing damage or hearing fatigue over time. The Goldstein '067 patent also describes modifying the audio signal presented to the user in response to an audiogram that characterizes a user's hearing sensitivity to compensate for the hearing loss that may be a function over frequency. While methods such as this may help improve intelligibility for audio content presented to a hearing-impaired user, the reality for in-ear monitoring systems is complicated by fact that they are used in environments that possess significant levels of background noise or disturbances that may reduce the intelligibility of audio content presented to the user. In realistic applications, intelligibility is limited by both the hearing ability for the user and auditory masking (clutter effect) caused by other audio disturbances. In order for in-ear-monitors to offer optimum practical benefit, a user must be provided with audio levels sufficient for intelligibility that at the same time do not fatigue or damage hearing as a result of use. Intelligibility, hearing damage and fatigue are functions of signal to noise ratio (SNR) and all vary on a case-by-case basis from one user to the next and furthermore depend on the given operating environment in which they work.

Co-pending provisional patent application No. 63/712,767, entitled “Frequency-based Compensation Filter for In-Ear Monitors”, filed on Oct. 28, 2024, by Matt Andersen, Steve Popovich and Christopher Mittlesteadt, which is incorporated by reference herein, discloses an in-ear-monitor that provides a frequency dependent level of amplification of sound levels and a reliable level of intelligibility as a function of frequency (while minimizing damage and/or fatigue). This co-pending application transmits digital, multi-channel audio data from the audio base unit (receiver pack) to the in-ear monitors, which in turn have digital signal processing (FPGA) that can filter the audio signal to account for ear specific hearing loss under a variety of sound masking conditions. Providing a metronome click track to the in-ear monitors in such a system is likely to interfere with the filtering for ear specific hearing loss and acoustic masking.

### SUMMARY OF THE INVENTION

The invention provides a haptic metronome actuator on an in-ear monitor to preferably vibrate an in-ear plug with pulses occurring at a synchronized timing, e.g. at a synchronized beat per minute (BPM). By integrating the haptic metronome actuator on the in-ear monitor, no additional physical set up is required to use the metronome as required with other haptic metronome actuators available in the prior art. The metronome signal also does not interfere with the audio signal or its processing even though it is provided to one or both of the in-ear monitors.

Placing the haptic metronome actuator on the in-ear monitor and in particular so that it stimulates the user's ear canal is not only convenient but also improves effectiveness since the ear canal is protected from the ambient acoustic and physical environment.

In the exemplary embodiment of the invention, the in-ear monitor system has a right side in-ear monitor and a left side in ear monitor, and an audio base unit such as a receiver body pack. The receiver body pack has an RF receiver configured to receive wireless data from a control console or other similar audio equipment that is normally operated by a sound engineer. The data transmitted to receiver body pack includes the digital audio signal as well as other control data. In accordance with the invention, the control signal for the haptic metronome actuator is transmitted from the receiver body pack to one or both the in-ear monitors along with digital audio data preferably over a connecting cable. In the disclosed example, the connecting cable has single active line and a ground line, and data is transmitted bidirectionally over the active line as time-division multiplexed serial data words. The bidirectional cable and its operation are disclosed in co-pending U.S. patent application Ser. No. 18/900,687, entitled “Bidirectional Multi-Channel Audio Link for Transducers,” filed on Sep. 28, 2024, by Matthew Anderson and Francois Morin, and assigned to the to the Assignee of the present application, which is incorporated by reference herein.

Each in-ear monitor has an audio transducer processing unit with a digital signal processor (e.g. FPGA) that de-multiplexes the digital audio data and the base device data transmitted to the in-ear monitor and outputs separate digital audio signals for each acoustic transducer on the respective in-ear monitor. For example, the in-ear monitors may have 2 or 3 acoustic transducers (speakers) a piece, and the digital audio data from the audio base unit is streamed serially as multi-channel digital audio data. The digital processor on the respective in-ear monitor also outputs a digital actuation signal for the haptic metronome actuator on the in-ear monitor. The transducer processing unit has multiple digital-to-analog converters for the acoustic transducers (speakers), each receiving one of the separate digital audio signals and outputting an analog audio signal which is then amplified to drive the respective acoustic transducer (speaker). The transducer processing unit also has a digital-to-analog converter for the haptic metronome actuator that receives the digital actuation signal for the haptic metronome actuator and outputs an analog actuation signal, which is amplified, to drive the for haptic metronome actuator on the respective in-ear monitor. The haptic metronome actuator is driven to vibrate in pulses occurring at a synchronized timing defined in the received base device data, for example at a selected BPM (beats per minute).

Each in-ear monitor has an exterior housing, and an in-ear plug housing that is configured to be placed in the ear canal of the user. The acoustic transducers (speakers) are in the exterior housing along with most of the electronic components in the in-ear monitor. If the in-ear monitor has two speakers, the in-ear monitor will preferably have a first acoustic chamber extending from the first speaker in the exterior housing into the in-ear plug housing and a second acoustic chamber extending from the second speaker in the exterior housing into the in-ear plug housing. The audio is mixed and output through an acoustic output port in the in-ear plug housing. In the exemplary embodiment, the haptic metronome actuator is mounted on the exterior housing of the in-ear monitor and is positioned such that when activated the haptic metronome actuator vibrates the in-ear plug housing.

A wide variety of electrotechnical vibration devices can serve as the haptic metronome actuator. In the exemplary embodiment, the haptic metronome actuator has an electric coil that moves a magnetic mass when activated to cause pulse vibrations, and the housing contains liquid to dampen vibrations in case there are issues with resonance.

The exemplary audio base unit (receiver body pack) has an RF receiver or transceiver to receive digital audio data and metronome data wirelessly from an RF transmitter of a control console operated by a sound engineer. It is contemplated that the control console communicates with several audio base units (receiver body packs) to provide the respective in-ear monitors digital audio data and metronome data. The overall system in this regard includes multiple in-ear monitors and audio base units (e.g. receiver body packs), and the audio base units each have an RF receiver or transceiver to receive digital audio data and metronome data wirelessly from the RF transmitter of the control console. One mode of operation is that the synchronized timing data is provided from the control console to each of the receiver body packs for multiple performers, where the synchronized timing is determined for a given song, e.g. at a synchronized beat per minute (BPM) determined for a given song is RF transmitted from the control console. Alternatively, it may be desirable to use a beat sensor that communicates with one of the receiver body packs and in turn transmits beat data to the control console. The center console in this embodiment then determines the synchronized timing based on the data from the beat sensor. In this way, a performer such as a drummer or a singer in a band can set the tempo for the remaining band members.

Each in-ear monitor optionally has a microphone in or adjacent its acoustic output port and situated to detect the user's voice through the user's respective ear canal. A transducer amplifier receives the analog signal from the microphone, and an analog-to-digital converter in the transducer processing unit converts the amplified microphone signal to digital transducer data. The digital transducer data is transmitted over the respective active line of the bidirectional cable as time-division multiplexed serial data words to the receiver body pack (audio base unit). The audio base unit or the control console includes voice recognition software so that the user can operate the haptic metronomes by voice commands. Alternatively, the voice signal can be relayed to a sound engineer operating the control console, and the sound engineer can take appropriate action.

In-ear monitors are commonly used by musicians, performers and sound technicians/engineers (collectively referred to as “users”) as a means of auditory feedback with regard to the sound they are producing oftentimes along with of one or more other members of their band. Historically, legacy hearing aids and custom molded in-ear monitors have been adapted for this role. Given the high sound levels that are typically present on stage, the use of in-ear monitors allows for a reduction in the risk of hearing loss to users, since the in-ear monitors block some or most of the ambient noise, while reproducing the desired audio at a lower (safer) level. As mentioned previously, a common problem associated with the use of in-ear monitors involves finding the optimal setting for in-ear sound levels that maximize intelligibility, but without introducing a risk of incurring hearing loss to the user. That many performers are experiencing some form of hearing loss complicates the ideal settings for such devices. In some instances, preferred device settings may be obtained empirically with a user providing feedback to a sound engineer in control of these settings until a satisfactory sound reproduction has been found. In addition to being time consuming and in many cases somewhat arbitrary (depending on mood, time of day, etc.), this mode of device configuration suffers from the risk that many users may not even themselves be aware that they have sustained hearing loss over the years, leading to settings that may be higher than desired for reasons involving risk of hearing loss and/or fatigue. Of course, restricting a device to a set of conservative settings for sound levels may provide protection for users against hearing loss, but at the same time this may not reliably provide a sufficient SNR for them to be able to judge performance based on the auditory feedback provided. When custom tuning in-ear monitors, the temptation remains to provide increasing sound levels to improve auditory intelligibility, which in many cases results in sound levels that are likely to cause further accumulation of hearing loss.

As mentioned previously, the above incorporated, co-pending U.S. Provisional Patent Application No. 63/712,767, entitled “Frequency-based Compensation Filter for In-Ear Monitors,” discloses a method of using frequency-based gain in the audio data to compensate for hearing loss and acoustic masking due to ambient noise. Importantly, when implementing the invention, the control data for the haptic metronome actuator is isolated from the digital audio data so the haptic metronome data does not affect filtering or processing of the digital audio data.

Other features and advantages of the invention may be apparent to those skilled in the art upon reviewing the following drawings and description thereof.

### BRIEF DESCRIPTION OF THE DRAWINGS

FIG. 1 shows an in-ear audio monitoring system using bidirectional links in accordance with an exemplary embodiment of the invention.

FIG. 2A shows components of an exemplary embodiment for the invention, namely an in-ear monitor including multiple acoustic output transducers (speakers) for improved sound reproduction and a haptic metronome actuator.

FIG. 2B contains a detailed illustration of the transducer processing unit 400 in the in-ear monitor of FIG. 2A according to the exemplary embodiment of the invention.

FIG. 3A illustrates an audio base unit (e.g. receiver body pack) configured in accordance with the exemplary embodiment for the invention.

FIG. 3B provides a functional diagram of compensation filtering and volume control incorporated into block 201 (FPGA, DSP or standard microprocessor for digital audio processing) of FIG. 3A in accordance with the exemplary embodiment for the invention.

FIG. 4A illustrates an example timing diagram of bidirectional serial communications achieved by applying time-division-multiplexing (TDM) toggling when two half duplex signaling components are located on opposite ends of a communications link. The time period shown corresponds to one sample period for the digital audio data.

FIG. 4B is a timing diagram similar to FIG. 4A modified to describe serial communication using time-division multiplexing (TDM) over the active line in the bidirectional link in a system having a right in-ear monitor and a left in-ear monitor.

FIG. 5 provides an example audiogram used to characterize hearing sensitivity and corresponding hearing loss based on hearing tests performed using the right and left ears of a human test subject referred to as “person-A”.

FIG. 6 illustrates a typical masking effect that may be expected due to the presence of a masking tone at frequencies near that for the masking tone. FIG. 6 further illustrates how additional tones located near the masking tone may be rendered inaudible due to the auditory masking effect in the human auditory system.

FIG. 7 shows example compensation filters that may be derived from data contained in the audiogram of FIG. 6 according to the exemplary embodiment of the invention.

FIGS. 8A through 8E provide data in support of example designs for an FIR compensating filter meeting the design criterion of FIG. 7 according to a simplified example.

FIG. 9 provides a block diagram illustrating construction for a hearing level compensation filter according to a more advanced example.

FIG. 10 illustrates construction of an example haptic metronome actuator according to the exemplary embodiment of the invention.

### DETAILED DESCRIPTION OF THE EXEMPLARY EMBODIMENT OF THE INVENTION

The invention disclosed herein provides means for in-ear monitors and audio base units to reliably exchange multi-channel audio data and control data (or metadata) including instructions to control haptic metronome actuators on the in-ear monitors. The exemplary embodiment allows for an inexpensive, simple bidirectional link that requires only a single shielded conductor paired with a grounding conductor. DC power for the in-ear monitors can also be provided over the bidirectional link. The bidirectional link uses can use commonly available connectors such as a 3.5 mm jack, ¼ inch headphone jack, BNC or RCA connectors and even standard USB connectors can be used.

The exemplary in-ear monitoring system described in this disclosure not only provides haptic metronome signals to assist performers with timing but also protects against hearing fatigue or hearing loss risk.

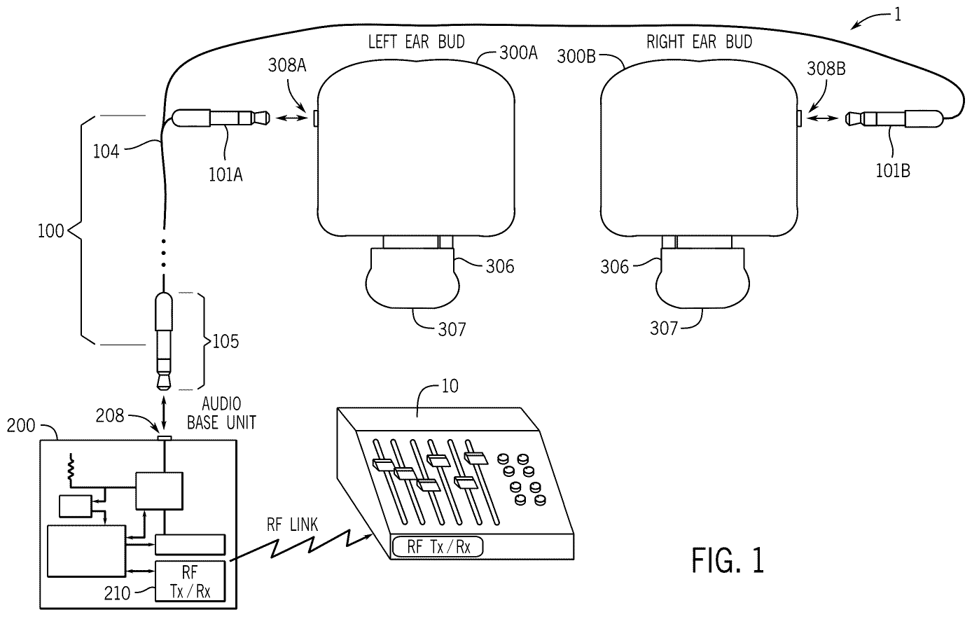

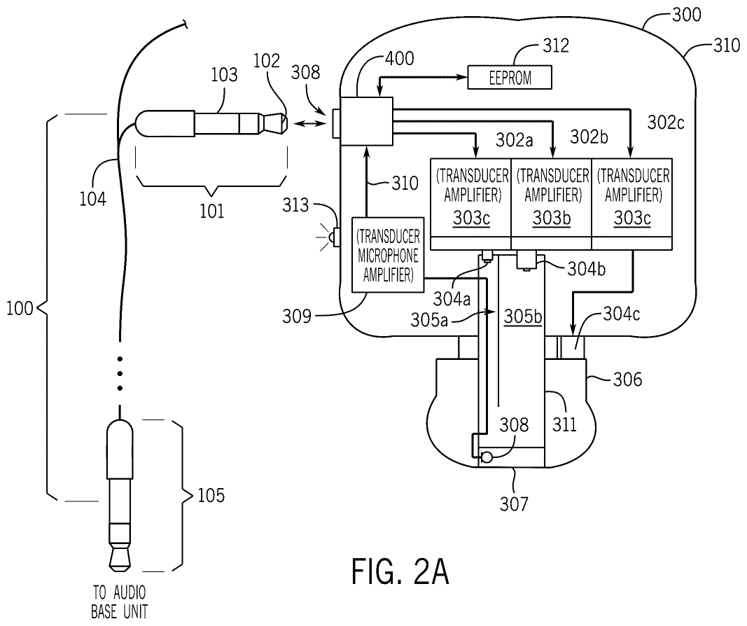

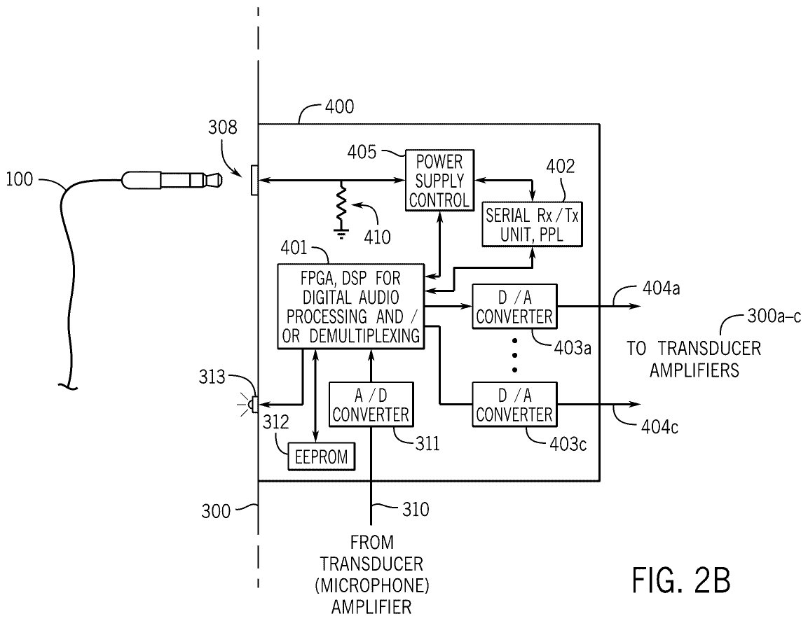

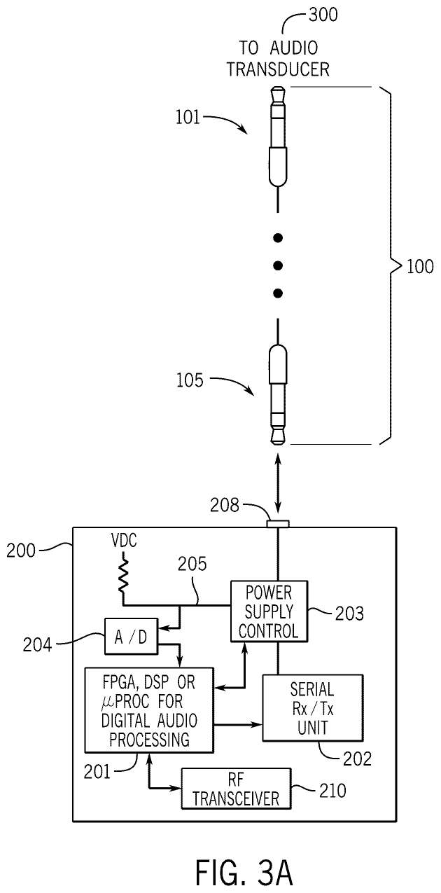

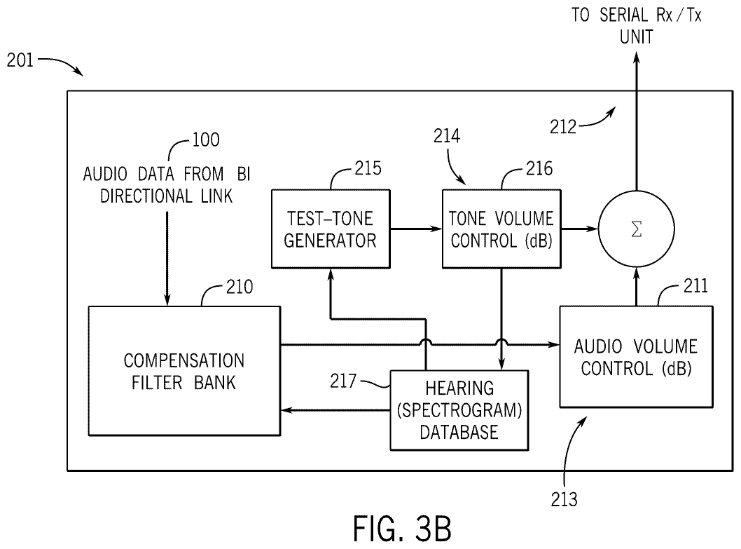

FIG. 1 shows an in-ear audio monitoring system 1 using a bidirectional link 100 in accordance with an exemplary embodiment of the invention. The in-ear audio monitoring system 1 is designed to be used by musicians when practicing or performing. There are three basic elements to the in-ear audio monitoring system 1. A control console 10 with an RF transceiver operated by a sound engineer. The control console 10 can be a rack-mounted mixer or mixer recorder with a display and screens or can be connected to a digital audio workstation as is known in the art. A belt-worn, receiver body pack 200 with an RF transceiver 210 that communicates via tuned UHF or VHF with the control console 10. Two in-ear monitors 300A and 300B, e.g. right side and left side in-ear monitors. The bidirectional link 100 physically connects to the right side and the left side in-ear monitors 300A, 300B to the receiver body pack 200. A jack 105 physically connects one end of the bidirectional link 100 to a port 208 on the receiver body pack 200. Jacks 101A, 101B physically connect the other end of the bidirectional link 100 to ports 308A, 308B on the in-ear monitors 300A, 300B respectively. Although not shown and a non-preferred alternative, the receiver body pack 200 can be configured to have a second audio output port, similar to port 208, in which case one bidirectional link can be physically connected between the receiver body pack 200 and one of the in-ear monitors 300A and another bidirectional link 100B can be physically connected between the receiver body pack 200 and the other in-ear monitor 300B. Multi-channel digital audio data and non-audio data are transmitted over the bidirectional link 100 using time division multiplexed serial data transmission as described in more detail below with respect to FIGS. 3A and 3B. On stage, a multi-channel audio mix is typically transmitted at a selected radio frequency from the rack mounted RF transmitter on the control console 10 to the RF receiver 210 on the receiver body pack 200. Then, the multi-channel audio is converted to a serial digital data stream, along with other control data, which is transmitted over the respective bidirectional link 100 to the in-ear monitors 300A, 300B. Data is also transmitted from the in-ear monitors 300A, 300B to the receiver body pack 200 over the bidirectional link 100, as described in more detail below. For example, as depicted in FIG. 2A, each in-ear monitor 300A, 300B includes a microphone 308 to monitor sound and/or sound energy level exposed to the user's ear canal. The microphone signal is converted to digital serial data in the in-ear monitor 300A, 300B, and is transmitted over the bidirectional link 100 via time division multiplexing. Typically, the in-ear monitoring system 1 will include several receiver body packs 200 and in-ear monitor 300A, 300B pairs, and the control console 10 will transmit the audio mix and otherwise communicate via the several receiver body packs 200. If desired, communication of data or instructions from a given pair of in-ear monitors 300A, 300B and receiver body pack 200 to another receiver body pack and pair of in-ear monitors can occur through RF transmission with the control console 10.

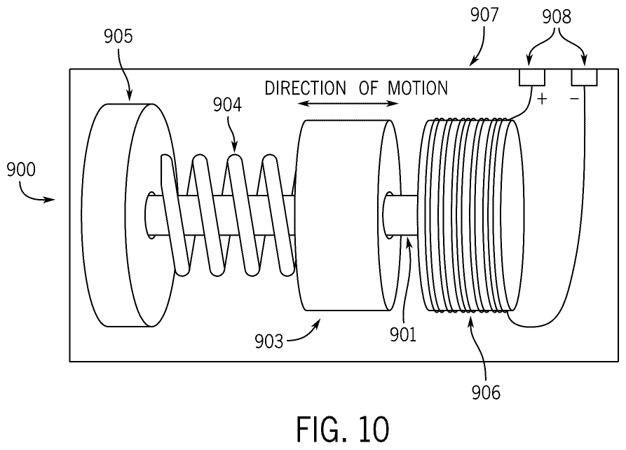

FIG. 2A illustrates components of an example an in-ear monitor 300 is linked to a RF receiver body pack 200 in FIG. 3A via the bidirectional link 100. In FIG. 2A, the in-ear monitor 300 has a soft in-ear flexible housing 306 containing an output port 307. Alternatively, the in-ear monitor can be a molded earpiece. The in-ear monitor 300 has an exterior housing 310 contains electronic components (such as analog signal amplifiers 303A-C and 309A), and acoustic output transducers (speakers) 304A-B. A microphone element 308 is mounted to the output port 307 and is configured to be inserted into the base of an ear canal of the user. The larger speaker 304B is efficient at creating lower frequency physical sound waves while the smaller speaker 304A is efficient at producing higher frequency physical sound waves. A haptic metronome actuator 304C is mounted to the exterior housing 310 and stimulates the in-ear plug housing 306 to provide haptic metronome stimulus, namely vibrational pulses at a synchronized timing. An exemplary haptic metronome actuator 304C is shown in FIG. 10. Other embodiments are envisioned where the haptic metronome actuator 304C is mounted on the exterior housing 310 to stimulate the output port 307 directly. In these cases, it may be desirable to omit the sealed actuator housing 907, FIG. 10, and attach the mount 901 to the output port 307 and attach the coil 906 to the exterior housing 310. This arrangement may be used to produce a pulsation sensation between the pinna and ear canal of a user's ear by modulating the distance separating the exterior housing 310 and output port 307. For some embodiments, the haptic metronome actuator may be mounted within the exterior housing 310 or within in-ear plug housing 306 or on the output port 307 itself to provide vibrational cues in response to a metronome signal provided over the bidirectional link 100.

The function of the haptic metronome actuator 304C is different from a haptic acoustic element intended to supplement an audio mix, such as providing simulated bass reverberations. In some embodiments, a timer (or rhythm generator) may be programmed into the transducer processing unit 400 of the in-ear monitor 300 or may be programmed in the processor 201 of the receiver body pack 200. While it is possible that the receiver body pack 200 worn by one performer communicate directly with another receiver body pack worn by another performer in the group, it is expected that the receiver body pack 200 will communicate via RF transmission with a control console or similar audio equipment operated by a sound engineer. The sound engineer selects or programs a synchronized metronome timing sequence that is multicast to all the receiver body pack 200 in the group. Alternatively, one or more of the receiver body pack 200 may be connected to a beat sensor that is used to detect a beat from one or more of the performers. The beat sensor can be a switch for a foot pedal, or an accelerometer or a microphone or pick up. If necessary, the signal from the beat sensor is analyzed to detect beats and/or a beat rate which is then used as the basis for the synchronized metronome timing sequence transmitted to the other receiver body pack in the group. The timing cues for the synchronized metronome timing sequence are preferably sent from the respective audio base units 200 to the respective in-ear monitors 300 via metadata over the bidirectional link 100.

In addition to acoustic elements designed to produce or detect a physical acoustic waveform, the audio transducer system 300 may also include one or more microphone elements 308 placed to detect sound levels representing the sound resulting in the ear canal from audio feedback presented to the performer while using this device. In some embodiments, it may be desirable to monitor ambient sound levels being experienced by the user. These levels may be calculated by the FPGA 401 (FIG. 2B) of the transducer processing unit 400. In some embodiments, it may be become desirable that sound levels be remotely adjusted so that the user can perceive a clear representation of the audio signal presented by the acoustic elements 304A-B to their ear canal, while avoiding levels so loud as to produce risk of hearing damage. In some embodiments, there may be cases where a sound engineer may wish to be able to receive (hear) verbal commands provided by the user while performing. In these embodiments, the microphone element 308 in the in-ear housing 307 is placed to enhance detection of the user's voice travelling through the Eustachian tube into the plugged ear canal in order to isolate the detected voice from the eternal (noisy) environment. Subsequently, the microphone output signal 310 is provided as the input to an analog-to-digital converter (ADC) 311 and then to the FPGA or microprocessor 401 of the transducer processing unit 400 for further processing, transmission or analysis, depending on the user's preferences. Since voice commands issued by the user are transmitted back down the bidirectional link 100 to the receiver body pack 200, and subsequently transmitted to the control console 10 (or other device) to it where it may be monitored by a sound technician (or analyzed with speech recognition software). The sound engineer (or software controls) may configure and/or control aspects of the in-ear-monitor including operation of the metronome feature in response to the voice command.

In some embodiments, it may become preferable to locate the microphone element 308 on the exterior housing 310 to allow it to monitor sound levels that are ambient to the user while performing

The ear-bud insert 306 may be constructed of a flexible silicon compound or soft memory foam in others. Sound waves produced by the output acoustic elements 304A-B waves are mixed through the ear-bud insert 306 that fits (or protrudes) into the ear canal of a user. In embodiments where the ear-bud insert 306 is composed of compression (memory) foam, it may naturally expand to fit perfectly (and comfortably) in the user ear canal. Even though this embodiment shows the use of two output acoustic elements 304A-B (apart from the haptic element 304C) in other embodiments, an arbitrary number of output acoustic elements may be preferred. Unlike the prior art, a “frequency divider” circuit is not required, since the shielded bidirectional cable 104 is able to serially transmit multiple distinct audio channels utilizing time-division-multiplexing.

Referring to FIG. 2B, a more detailed diagram for the audio processing unit 400 within the audio transducer 300 is presented. Internal to the audio processing unit 400, The audio processing unit 400 may receive DC power that is superimposed over communications being send through the bidirectional link that is isolated by a power supply isolation circuit 405. In this circuit capacitive coupling allows for serial communications signals generated (or received) by the serial transceiver 402 to be superimposed onto the DC voltage level. The serial audio data is received from the bidirectional link 100 by a serial transceiver 402 where it may be converted to, for example, PCM data streams. The PCM data streams are de-multiplexed by an internal FPGA, DSP, microprocessor or microcontroller 401 into distinct PCM data streams that are presented to a set of digital-to-analog (D/A) converters 403a and 403b. While the exemplary embodiment describes the use of PCM data streams, it is contemplated that the invention could be implemented with audio data streams encoded in other formats than PCM. Subsequently, the analog output 404a and 404b from the D/A converters 403a-b is applied as input to a set of analog amplifiers 302a through 302b, FIG. 2A, respectively for driving the speakers 304a and 304b. The acoustic elements (speakers) 304a and 304b produce a physical waveform in chambers 305a and 305b that propagate through the output port 307 into the ear canal of the user to be heard by the user.

The analog signal 310 from the output of the microphone transducer amplifier 309A (FIG. 2A) is applied to an analog-to-digital converter 311 to produce a data stream that is processed by the FPGA 401 and returned to the audio base unit 200 via the serial transceiver 402 utilizing time-division-multiplexing (TDM) to facilitate bidirectional serial communication. For some embodiments, the word clock may run at a 48 MHz rate. This disclosure also envisions the use of higher word clock rates such as 96 MHz.

The illustrated bidirectional link 100 is a cable with 3.5 mm jacks, however, a wide array of connectors may prove suitable and are envisioned by this disclosure. Referring to FIG. 2A, in the preferred embodiment, the cable portion 104 of the bidirectional link 100 contains at least two conductors: 1) a signal line (i.e the active line connected to tip connector 102 on the jacks 101, 105) carrying bidirectional serial data superimposed on a DC power supply and 2) a ground line connected to the ring connectors 103 on the jacks 101, 105. The ground line 103 can also serve as the cable shielding. Although the use of 3.5 mm headphone jacks is illustrated, a segment of 50 ohm coaxial cable may be serve as the cable portion 104 of the bidirectional link 100, where simple BNC connectors placed at each end may serve as a means to connect the end-point connectors 101 and 105 with the ports 308 and 208 (in this case configured to receive a BNC connector) on the audio transducer 300 and base unit 200 respectively.

Desirably, once a bidirectional link 100 is provided between an audio base unit 200 and transducer processing unit 400, a limited (test) DC supply 205 (FIG. 3A) is superimposed on the active line. An ID resistor 410 (FIG. 2B) in the audio transducer 300 creates an identifiable voltage drop in line 205 (FIG. 3A) that is measured by an analog-to-digital converter (A/D) 204 housed in the audio base unit 200. The value for the detected ID resistor may then be determined and referenced to a library of values to confirm the interoperability of serial communications over the active line 102 of the bidirectional link 100. Once this has been established, the audio transducer processor unit 400 may retrieve a factory programmed ID (along with other settings) from internal non-volatile memory and communicate these to transceiver unit (Rx/Tx) 202 in the audio base unit 200 to be interpreted by a processing unit 201. The audio transducer 300 may additionally serially transmit a structure of information to the base unit 200, including information such as the type of transducer 300, its power/based voltage requirements and desired serial protocol for the exchange of audio information such as the number of channels and type of audio (e.g. sample rate, 16, 24 or 32 bit) and/or user settings, etc. In some embodiments, the audio base unit 200 may contain a library of settings to allow it to configure a wide array of audio transducers 300 (or other compatible equipment) after they are connected. In cases when an audio base unit 200 identifies a compatible (and configurable) audio transducer 300, the audio base unit 200 may send a compatibility success message to the audio transducer, causing it to light an externally visible LED 309 to alert the user that the devices (200 and 300) are indeed interoperable via the hardware providing the bidirectional link 100. In these cases, the audio base unit 200 may enable a DC supply voltage of bias voltage (often used by microphones) via an internal array of analog switches 203 controlled by a processing unit 201. In a preferred embodiment, a current limit of 100 mA may be imposed on the supply to protect components in either the based unit 200 or audio transducer 300. Preferably, serial communications between the units 200 and 300 proceeds at 48 MHz in a format that is similar to the Multichannel Audio Digital Interface (MADI), as described by the AES10 standard of the Audio Engineering Society. If serial data from the audio base unit 200 includes a known sequence that is periodically transmitted, a PLL located in the serial Tx/Rx unit 402 of the transducer processing unit 400 of the audio transducer 300 may synchronize itself to it to derive a word-clock signal synchronized to the audio base unit 200. In the preferred embodiment, a green LED 313 (FIG. 2B) visible from an external portion of the audio transducer 300 enclosure may be illuminated to indicate interoperability, while a red (or flashing red) LED 309 may indicate the failure of the devices (200 and 300) to establish bidirectional serial communications. When compatibility is not indicated, the DC power supply or bias voltage may then remain inactive to prevent any damage if connected to an unknown (older) audio transducer 300. At this point, the absence of a green LED 313 (or presence of a flashing red LED) may notify the user that no (potentially damaging) DC voltage or bias voltage has been activated.

The simplicity and flexibility for the type of cable portion 104 and associated connectors 101 and 105 provide further advantages. Users can maintain confidence that the interconnection between audio transducer 300 and base unit 200 will function nominally despite the use of simple, inexpensive, readily available and easy to understand hardware serving as a bidirectional link 100 between the audio these units. Those skilled in the art will understand that aspects of the invention can be implemented if the bidirectional cable 100 is connected permanently to the audio transducer 300, thereby avoiding the need for transducer connector jack 101. For example, the bidirectional cable can be connected permanently to the pair of in-ear monitors 300A, 300B. Or, a segment of bidirectional cable can be connected permanently between the pair of in-ear monitors 300A, 300B (FIG. 1) and a jack on the main segment of the bidirectional cable from the receiver body pack 200 can connect to a port on the segment between the in-ear monitors 300A, 300B.

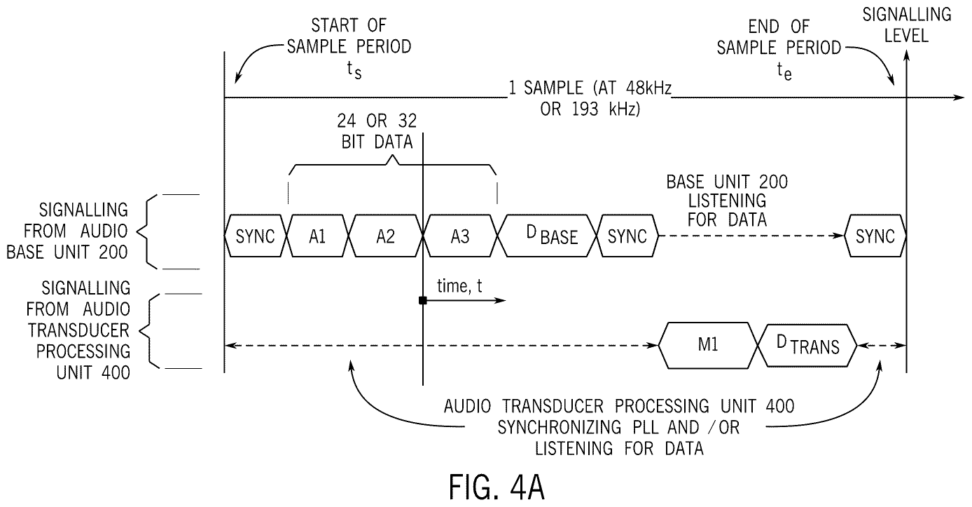

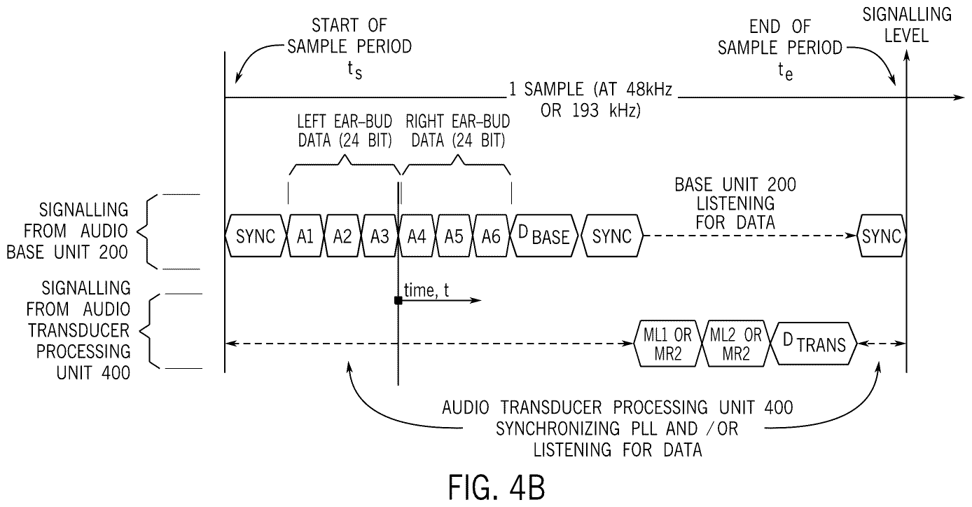

The exemplary embodiment uses half-duplex, bidirectional serial communications over the active line in the bidirectional link 100. A half-duplex serial communications link at each endpoint (200 and 300) of the bidirectional link 100 provides a simpler means for bidirectional communication through a single conductor. In these cases, time-division multiplexing may facilitate bi-directionality of communications across the link 100, by employing time-division-multiplexing between the serial transmitters 202 and 402 in the audio base unit 200 and transducer 300 (that is, within the transducer processing unit 400 of the audio transducer 300), respectively. A timing diagram illustrating the concept is provided in FIG. 4A. This figure illustrates a timing diagram over the span of a single sample period that may correspond to the audio sample period. In many cases, the audio sample rate may be preferably range from Fₛ=48 kHz to Fₛ=192 kHz, and for most embodiments, preferably no less than 8 kHz. In general, an arbitrary audio sample rate (e.g. any value within a continuous supported range) may be selectable (programmable) by the user. In either case, the time spanned between the start of a sample period (as labelled tₛ on the upper left side of FIG. 4A) and the end of a sample period (as labelled tₑ on the upper right side of FIG. 4A) is

$${t}_{e} - {t}_{s} = \frac{1}{{F}_{S}} ( seconds ) .$$

This protocol may be repeated over each sample period where the end-time tₑ for each end of a given sample period corresponds to the start-time tₛ for the next sample period. Signaling activity from the base unit 200 and audio transducer processing unit 400 are labelled on the left side as “Signaling from audio base unit 200” and “Signaling from Audio transducer processing unit 400”, respectively. The signaling over time is readily envisioned by considering the intersection between the vertical line, labelled “time” and the base unit signaling (top waveform in FIG. 4A) and audio transducer signaling (lower waveform in FIG. 4A) waveforms as it progresses from left to right with the passage of time over the sample interval. Initially, at the start of a sampling interval (where t=tₛ), the base unit 200 may emit a predetermined synchronizing word that facilitates lock for a PLL 402 operating in the transducer processing unit 400 of the audio transducer 300 to generate a word-clock reference. The transducer processing unit 400 may then prepare to receive audio data from the base unit 200, starting with the first channel, where a 24- or 32-bit PCM word is denoted by the label “A1” in the diagram. For some embodiments, the use of a different number of bits or a different format (e.g. floating-point) may be preferable. The base unit 200 may then continue to sequentially transmit the audio sample corresponding to each remaining channel “A1” through “A3”, where (for this example three channels are assumed) in general, an arbitrary number of channels may be sequentially sent. Once the transmission of the final audio sample is complete, the base unit may then continue by transmitting device data (as labeled by the packet D_{base} in FIG. 4A). This data may include command settings, environment status, metadata, acknowledgement for the receipt of data (sent earlier) from the transducer processing unit 400 or any other information that it may be desirable for the audio base unit 200 to be able to communicate to the audio transducer 300. In some embodiments, the metadata my contain triggering and/or timing information for synchronizing pulses created by the haptic actuator to events communicated to the audio base unit by any other devices (such as a feed from a kick drum, snare drum, or click track) that are either connected via their own bidirectional links 100 or networked to it. Network links envisioned by the embodiments of this disclosure include those based on Ethernet, CAN (J1939) or general wireless LAN connections.

Following the conclusion of any metadata, the base unit 200 may transmit another synchronizing word that may notify the transducer processing unit 400 that it may begin transmitting its audio data (or in some embodiments this may be sound level data) in the desired format, as denoted by “M1” in the diagram. Again, an arbitrary number of channels of data may be sequentially sent by the transducer processing unit 400 (e.g. M1, M2 . . . etc.). After, the completion for transmission of data from the transducer processing unit 400 (pertaining to the given sample period) to the transceiver 202 within the audio base unit 200, the transducer processing unit 400 may continue by sending a data word (labelled Dₜᵣₐₙₛ in FIG. 3) that includes information related to signal analysis or acknowledgment of changes to device settings for operation of the audio transducer 300. For embodiments where two in-ear monitors 300A, 300B are attached to the bidirectional link 100 as shown in FIG. 1, the data packet D_{base} also desirably contains address data to notify the in-ear monitors 300A, 300B that the receiver body pack 200 is ready to receive monitored sound related data, denoted by ML or MR in FIG. 3B if derived from the left or right in-ear monitors, respectively. Again, an arbitrary number of channels of data may be sequentially sent. For example, if two in-ear monitors 300A, 300B are used as shown in FIG. 1, it may be preferred that the audio base unit 200 toggle requests for audio data between the left and right in-ear monitors from one sample period to the next. In this case, each transducer processing unit 400 (of the left or right in-ear monitor 300A, 300B) sends two data words to represent the two samples, (ML1 and ML2 or MR1 and MR2, respectively) since each will only receive a request for data every other sample period. As shown in FIG. 3B, it may be more convenient to use a protocol where the audio base unit 200 transmits data for all three transducers in both the left and right earbuds during every sample period. In the example in FIG. 3B, data words A1-A3 correspond to transducers 304a-c in the left in-ear monitor, while data words A4-A6 correspond to the transducers 304a-c of the right in-ear monitor. After, the completion for transmission of data from the transducer processing unit 400 (pertaining to the given sample period) to the transceiver 202 within the audio base unit 200, the transducer processing unit 400 may continue by sending a data word (labelled Dₜᵣₐₙₛ in FIGS. 3A and 3B) that includes information related to signal analysis or acknowledgment of changes to device settings for operation of the audio transducer system 300. Finally, at the conclusion of this, the base unit 200 may continue by transmitting a final synchronizing signal until the end of the sample period (where t=tₑ) before the system continues with commencing similar operations over the next sample period.

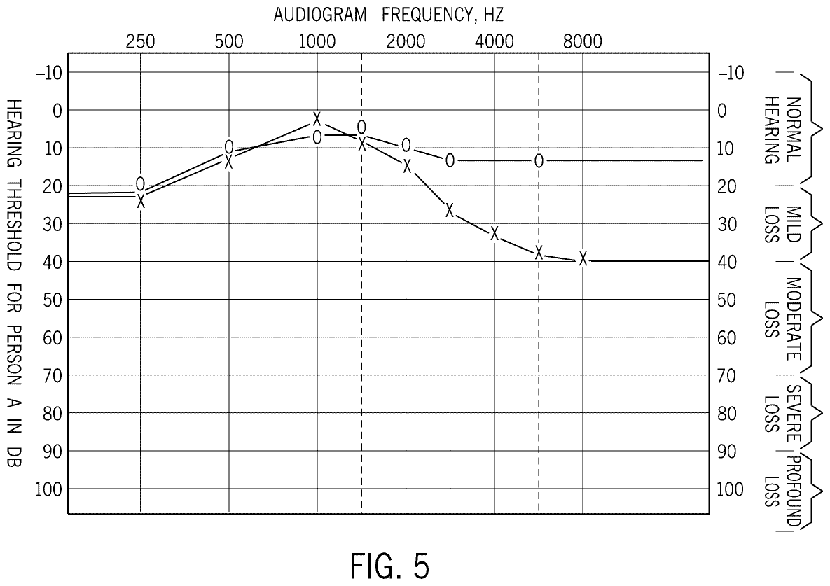

Generally, the hearing sensitivity for an individual (referred to as “person-A”) may be characterized by a chart as shown in FIG. 5 where for a set of frequency points, a minimum (softest sound level) detectable decibel (dB) level is plotted for the right and left ears of the individual. The dB levels referenced here are levels relative to a person with normal hearing. Generally, in the art, diagrams such as the one shown in FIG. 5 are often referred to as “audiograms”. In the audiogram of FIG. 4, the symbols “O” are used for the right ear sensitivity data (measurement) points, while the symbols “X” represents data points for the left ear sensitivity. Typical audiograms provide measurements for a frequency range slightly broader than human speech. To accommodate this, data is often collected at frequencies of: 250 Hz, 500 Hz, 1 kHz, 1.5 kHz, 2 kHz, 3 kHz, 4 kHz, 6 kHz and 8 kHz. The level of hearing loss is indicated by brackets on the far right hand side of the chart. For example, at 1 kHz, data from FIG. 4 indicates person-A has a left ear threshold of about 2 dB for detectability (normal sensitivity), while person-A's right ear has about a 6 dB threshold (still considered within normal sensitivity) of detectability. These data points are relative and made in reference to a 0 dB level that is considered the lowest threshold of hearing for a normal person (having no hearing damage) while listening in a quiet environment. At 1 kHz, 0 dB corresponds to a power density of approximately 10⁻¹² W/m². It is worth noting that the dB values for hearing threshold along the y-axis on left portion of the chart increase as the position approaches the lower portion of the chart in FIG. 5. In other words, lower data points on this chart indicate an increased hearing deficit. Continuing with this example, FIG. 5 indicates that person-A possesses approximately 40 dB hearing deficit (borderline between mild and moderate hearing loss) for their left ear at higher frequencies (near 8 kHz), while at lower frequencies (near 250 Hz), their hearing sensitivity is more similar (with approximately a 20 dB deficit in common) between their right and left ears. Ideally, for a person with normal (undamaged) hearing, the data plots for the various frequency points will lie near or close (within 20 dB) to the 0 dB line. It is important not to interpret the data of FIG. 5 as representing absolute sound pressure levels (SPL) values where an individual becomes sensitive to a sound for a specific dB level. For example, the right ear data from FIG. 5 indicates a right ear hearing threshold of about 10 dB at 2000 Hz for person-A. In other words, the sensitivity for person-A's right ear hearing is within the zone of normal hearing at 2000 Hz. The hearing threshold is about 13 dB is indicated at the frequencies of 3 kHz, 4 kHz, 6 kHz and 8 kHz, which is still in the sone for normal hearing. Overall, the hearing sensitivity for a given SPL will vary between 0 dB and 20 dB even for a person with normal hearing. There is a hearing deficit for person-A's right ear (“O”) at 250 Hz, where they would require an amplification to detect sounds that person with normal hearing would hear. An important attribute of hearing loss is that it is rarely consistent over the full frequency range for human hearing. In other words, it is rare to measure an audiogram where the data points (appear to) form a level line at some dB value. It is fairly common (especially with age) for individuals to suffer a hearing loss that is more pronounced at higher frequencies like the left ear data (X's) shown in the example chart shown of FIG. 5. In many cases, hearing loss may manifest in the form of a frequency notch where for a specific frequency, a person may experience a significant loss in sensitivity, while their sensitivity for other frequencies may remain relatively intact.

Hearing loss remains quite common among our population. According to the Centers for Disease Control and Prevention, hearing loss is the most common preventable work related injury with about 22 million people in the U.S. being exposed to hazardous levels. While the exact type of hearing loss experienced from one person to the next may vary widely, the effects of noise masking can affect anyone. It should be emphasized that auditory masking can affect both hearing impaired and normal hearing individuals. An example for auditory masking in the frequency domain may be better understood by considering the content of FIG. 5.

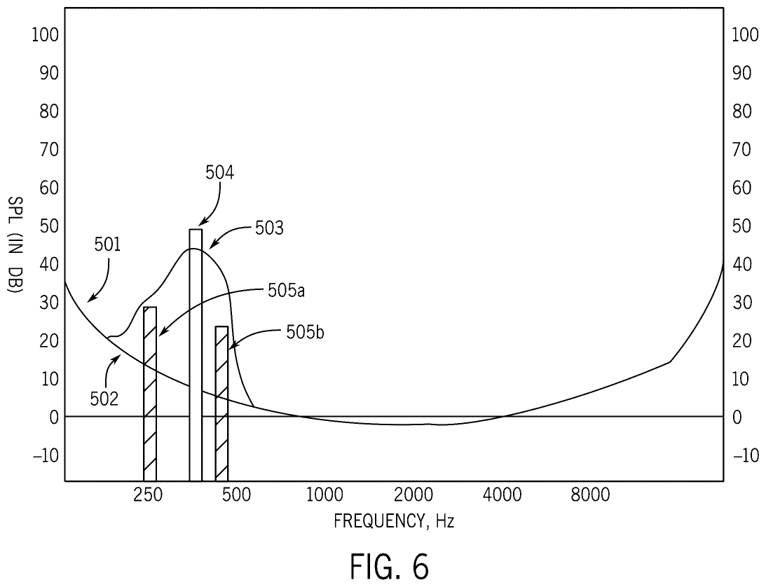

While the data from FIG. 5 is presented in terms of a relative dB offset, the data for FIG. 6 shows data representing a typical threshold of hearing in absolute SPL levels. In this diagram, the curve 501 labeled “(unmasked) Threshold of Hearing” indicates levels that are just detectable by a person with normal hearing. For example, in the range of 2000 Hz o 4000 Hz an individual with normal hearing can just barely detect a sound pressure level of −2 dB SPL. As indicated from this chart, human hearing is the most sensitive in the range of 2000 Hz to 4000 Hz. In contrast, the data point, 502 labeled “(unmasked) Threshold of Hearing at 250 Hz” indicates that a normal person's ear (without masking) will just be able to detect a 250 Hz tone having a level of about 12 dB SPL. Generally speaking, auditory masking refers to how the presence of sound may diminish the perception of other sounds by an individual. In some cases, it may render certain sounds that would otherwise be detectable inaudible to the point where a listener may remain unaware of them. For example, if a “masker” 504 is present (as shown) at approximately 350 Hz, sounds of similar amplitude that are nearby in frequency (as indicated by “Masked Tones” 505a and 505b may be rendered inaudible to a person with normal hearing—even though they are both well above the (unmasked) threshold of hearing for a normal person. From this point of view, the presence of masking sounds may be interpreted as imposing a temporary signal dependent hearing impairment to a listener, regardless of whether they have normal or impaired hearing.

In the event that a sound expert is using a set of in-ear monitors to assess the sound quality for various attributes of a performance, they will inevitably be exposed to a variety of masking sounds (other instruments, crowd, equipment noise, etc.) that combine with any hearing loss they possess that will hinder their ability to assess audio performance (or quality).

When a person having a notch hearing impairment attempts to assess an audio attribute lying in their specific frequency range for hearing loss, they may experience a temptation to increase the volume for an in-ear monitor (in an attempt to render it more perceptible). However raising the volume also increases the effects of masking sounds—potentially resulting in a cycle where a continuing desire for further improvements in perceptions leads to ever increasing volume settings that ultimately result in an in-ear SPL that is unhealthy for the user. In the worst case, this may create a risk of causing fatigue or hearing loss for their auditory system with long term use and may even lead to users violating standards set by the U.S. Dept. of Labor—Occupational Safety Health Administration (OSHA) for hearing protection.

For example, OSHA standard limits for permissible noise exposure are summarized in Table 1.0 below:

TABLE 1.0
Exposure limits (see: https://www.osha.gov/laws-
regs/regulations/standardnumber/1910/1910.95)

| Maximum permissible | | |
|---|---|---|
| time (hours)/day | Sound Level | |
| 15 minutes | 115 | dB SPL |
| or less | | |
| ½ | 110 | dB SPL |
| 1 | 105 | dB SPL |
| 2 | 102 | dB SPL |
| 3 | 100 | dB SPL |
| 4 | 97 | dB SPL |
| 6 | 95 | dB SPL |
| 8 | 90 | dB SPL |

Embodiments of this invention are envisioned where an in-ear monitor may track the in-ear SPL levels (using microphone 308 FIG. 2A) and cross reference the results to the information of Table 1.0 for the purpose of alerting users if an inappropriate noise exposure risk has been identified.

In this sense, hearing impaired users are at particular risk of attempting to overcompensate with excessive volume levels while attempting to better assess audio performance.

An object of this invention is to compensate the amplitude for an auditory signal over frequency that when presented to the ear of a hearing-impaired user will better approximate the intelligibility that would be achieved if a similar (non-compensated) signal was provided to a normal hearing user. Another object of this invention is to partially compensate for the effects of auditory masking customized to a specific user and environment on an as-needed basis over frequency to further enhance intelligibility. FIG. 3B illustrates how a compensation filter and volume control may be integrated into the signal flow of audio data received from the bidirectional data link 100 by the processor block 201 in the audio base unit 200 from FIG. 3A. As indicated, the user (listener) may adjust the volume level 211 on a dB basis to suit their preferences. In general, turning up the volume level 211 will increase the SNR perceived by the user and correspondingly improve the intelligibility for the user to perceive attributes of the audio signal.

In order to satisfy the objective of compensating for a combination of hearing deficit and auditory masking, an in-situ audiogram may be performed for a user in their working environment. For example, they may choose to perform the audiogram test in the presence of other equipment and/or musical instruments that are intended to be present while the in-ear monitor is to be used. A test tone generator 215 as illustrated in the apparatus of FIG. 3B may be used to superimpose an output test tone of specific amplitude onto the audio signal 212 that is sent to the in-ear monitor. Specifically, when requested by a user, a test tone generator 215 may be activated to supply (or add in) a test tone of amplitude determined by a user controlled test tone volume adjustment 216. Upon presentation of the tone, a user may then adjust the test tone volume control 216 such that they can just barely perceive the presence of the tone. For some embodiments, it may be advantageous to pulse the tone on and off every 500 ms or so to allow the user to more quickly assess their perception of it. In some (simpler) embodiments, it may be desirable to provide the user with a rotary control knob 216 (encoder) that provides a series of rotational detent positions, where rotating clockwise, increases the tone amplitude by 1 dB for each (detent) click. Similarly, the test tone amplitude may decrease for 1 dB for each counterclockwise rotational (detent) click. When the user is satisfied that their threshold has been reached, they may press the encoder to signal to the hearing (spectrogram) database 217 that the current value indicated by the encoder represents a threshold value that should be stored as part of an audiogram for the frequency of the test tone. This process may proceed from one test frequency to the next until data collection is complete. Since this test may be conducted in the presence of expected auditory masking sources, the user's individual threshold of hearing coupled with their individual response to any auditory masking will be quantified by the volume setting that corresponds to their ability to just hear the presence of the tone. Repeating this process for a predetermined set of frequencies, such as those indicated by FIG. 5 may produce an audiogram that includes auditory masking deficits. Upon completion for collecting an in-situ audiogram, the collected data may be stored by the processor 201 in the database 217 and associated with a user and testing environment. Generally, these may be collected for multiple users and environments and later recalled (upon request by a user) when an in-ear monitor is to be used in a corresponding environment by a specified user. For example, a user may want to quantify audiogram data for later use in a live performance in dependence on the expected size of a crowd, ambience of a stage or theater and/or the presence/use of various musical instruments.

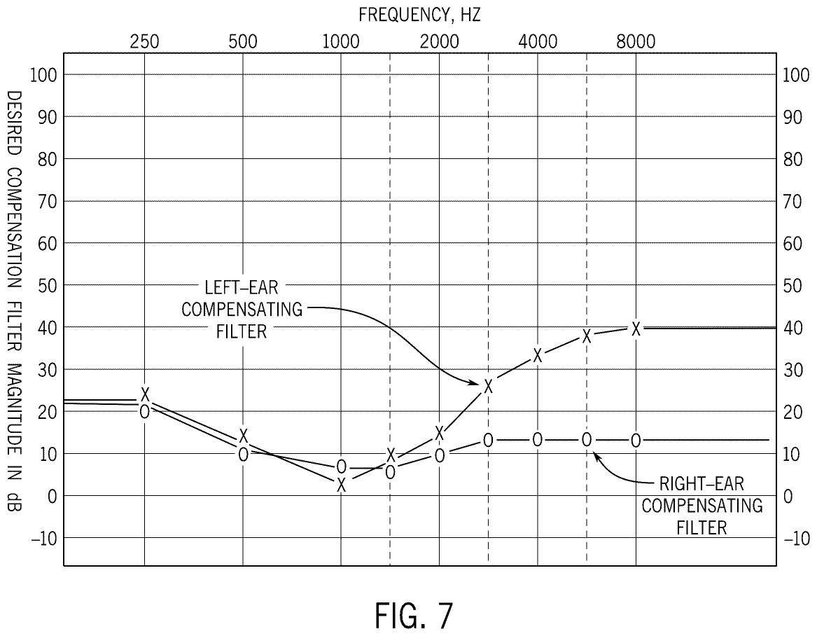

For example, assume that an in-situ audiogram for person-A resulted in the data 217 as displayed in FIG. 5. In order to compensate for the dB deficit at each test frequency, a filter having an inverse gain at each frequency point may be positioned in the base unit processing unit 201 as shown by the processing block 210 (FIG. 3B). While many options exist for designing such a filter, attributes that are generally desirable include low latency and when possible (within latency constraints) linear phase. A well-known window design method may be used to produce a relatively short FIR filter approximating these desired attributes. Inverting the gain at each frequency point in FIG. 5 produces data as shown in FIG. 7. Optimally, a distinct custom designed compensating filter 210 may be designed separately for the right and left ears for a variety of operating environments, based on the corresponding data. Continuing with this example for person-A's left ear, assume a short FIR filter (operating at a sample frequency of F_{S}=48 KHz) is desired for the compensation filter 210 with the following gains as summarized in Table 2.0 (taken from FIG. 7) below:

TABLE 2.0
Gains for optimal (left) filter 210 (data taken from FIG. 7)

| Frequency | Gain |
|---|---|
| (Hz) | Level (dB) |
| 0 | 25 |
| 250 | 25 |
| 500 | 15 |
| 1k | 3 |
| 1.5k | 8 |
| 2k | 15 |
| 3k | 27 |
| 4k | 33 |
| 6k | 37 |
| 8k | 40 |
| Fs/2 = 24k | 40 |

Following the window based design for an FIR filter, start by setting a normalized frequency and amplitude vectors as

$$f = [ \begin{matrix}0 \\ 0.01014 \\ 0.0208 \\ 0.0417 \\ 0.0625 \\ 0.0833 \\ 0.125 \\ 0.1667 \\ 0.25 \\ 0.333 \\ 1\end{matrix} ] and m = [ \begin{matrix}17.7828 \\ 17.7828 \\ 5.6234 \\ 1.4125 \\ 2.5119 \\ 5.6234 \\ 22.3872 \\ 44.6684 \\ 70.7946 \\ 100 \\ 100\end{matrix} ]$$

The elements of f are obtained from the corresponding frequency data values divided by (F_{S}/2). The gain values of m may be obtained by converting the values from dB into linear gain from Table 2.0. As an example, assume Nₕ=1024 point FFT routine can be implemented in the processor 201 with an FIR filter containing Nₜ=100 taps From these, we can construct a magnitude template by filling an (Nₕ/4+1)×1 vector, ma, where for each element, the magnitude linearly scales between values from m, where the (Nₕ/2+1) indexes are normalized from 0 to F_{S}/2. For this example, we have chosen Nₕ/2=512, we can set ha(1)=17.7828 for the magnitude at zero frequency in f. Similarly, we can set Ha(128)=70.7946

$$( noting that 0.25 * \frac{{N}_{h}}{2} = 128 )$$

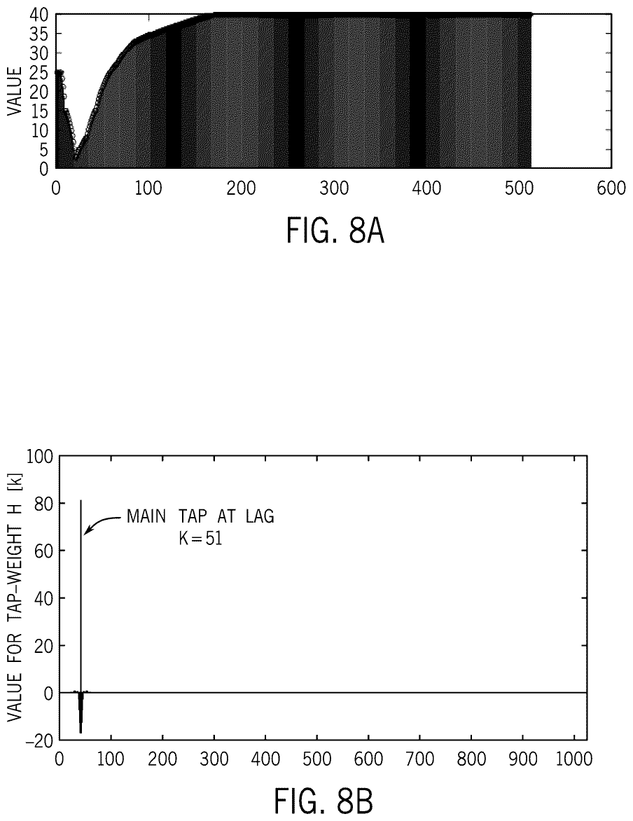

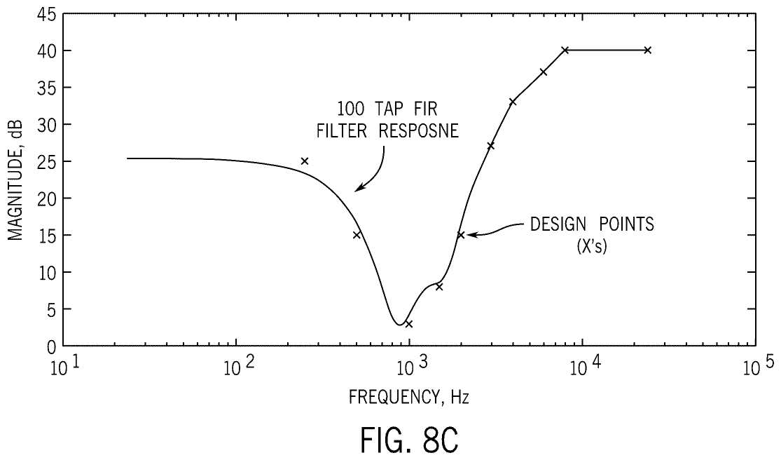

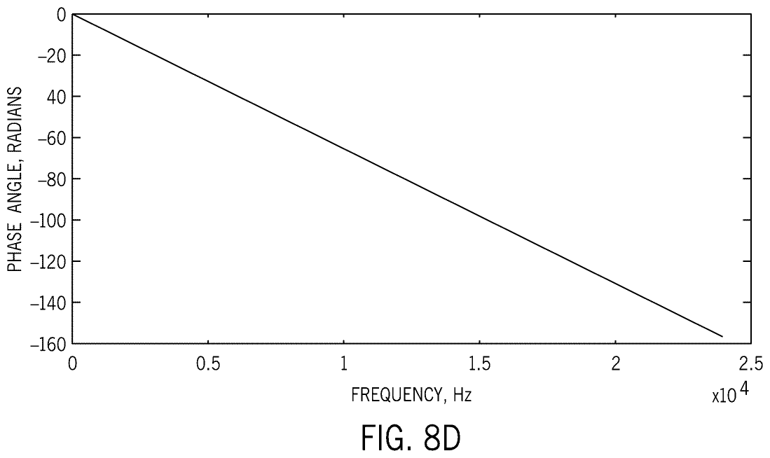

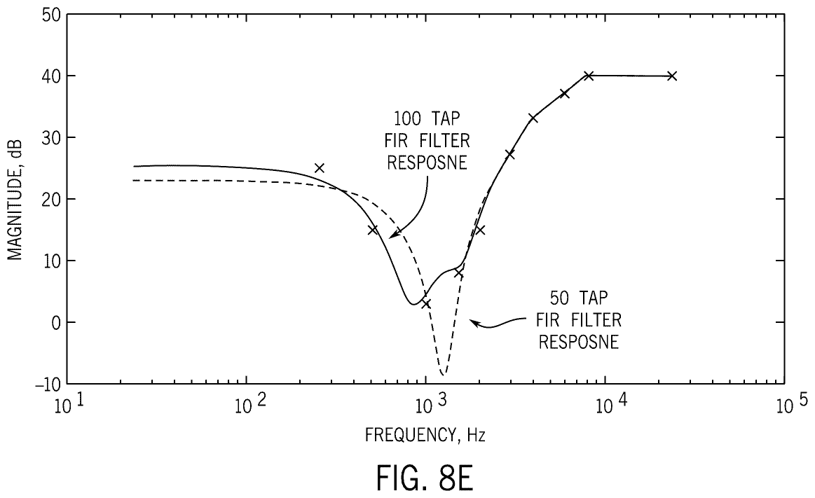

for the frequency point f=0.25 above. These values will then linearly increase to Ha(171)=100 for the frequency point f=0.33 above. Applying this technique across the entirety of the (N+1) indexes for ma, results in the 512×1 amplitude vector plotted in FIG. 8A. The plot of FIG. 7A may be viewed as an amplitude template for the desired frequency response. Generally speaking, taking the inverse transform for an arbitrary collection of points yields complex valued results.

Applying a phase value to each element of Ha can provide for an inverse transform that is both real and causal (by shifting Nₜ/2 indexes to the right in the time domain) by multiplying with the following phase vector, where for all k<Nₕ:

$${H}_{a} ( k ) = {H}_{am} ( k ) {e}^{( \frac{- j ( k - 1 ) {N}_{t} / 2}{{N}_{h}} )}$$

Applying symmetry properties yields a real-valued result by appending a mirror image of Hₐ to construct a 1024×1 complex (frequency-domain) vector, H as:

$$H = [ {H}_{a} ; flip ( conj ( {H}_{a} ) ) ]$$

The flip operation in the above equation reverses the order of the elements across the vector, while the conj function takes the complex conjugate for each value. Applying this to the data from FIG. 8A and taking the inverse (1024 point) FFT results in the FIR filter taps plotted in FIG. 8B.

$$h ( k ) = {FFT}^{- 1} \{ H \}$$

Although this yields (for this example) a 1024 length sequence, most of the meaningful tap values occur near the main pulse at around a lag, k=50, while taps at a significant distance from this lag (k>Nₜ) are very close to zero. A simple window function may serve to simplify the response by trimming off tap values (near the end of the sequence) that will have little impact on the filter output. As a simple example, a rectangular window function may be applied with the following equation where the applied window function (in this case) is a rectangular window

$${h}_{w} ( k ) = h ( k ) w ( k ) , for k = 1 to 1024 where w ( k ) = \{ \begin{matrix}1 , & k < {N}_{t} \\ 0 , & k \geq {N}_{t}\end{matrix}$$

Resulting in a 100-tap FIR filter, h_{w}(k) as shown in FIG. 7B.

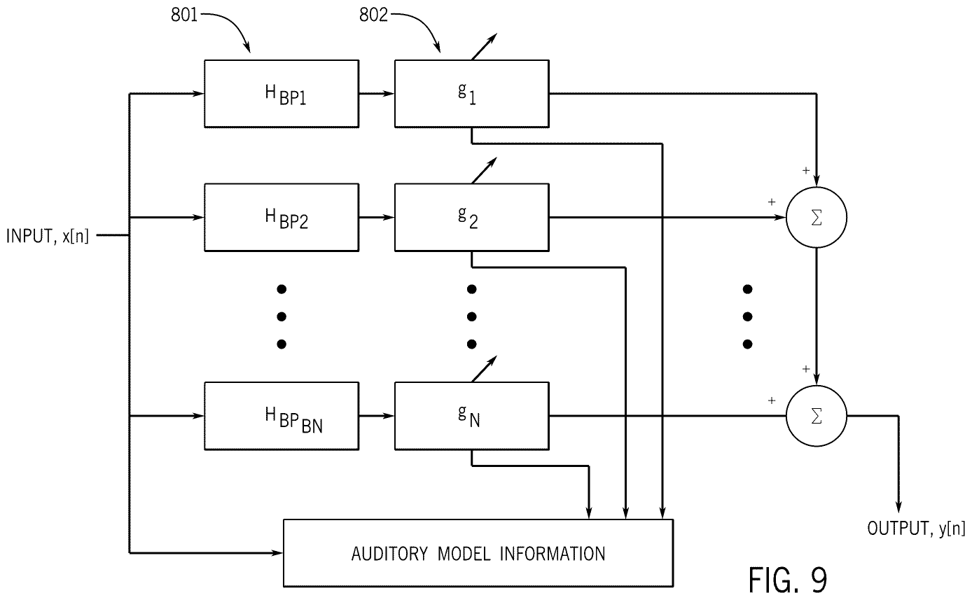

FIG. 8C illustrates the amplitude for the frequency response compared to the original design points (left ear—X's) from FIG. 6. FIG. 7D shows that the phase for the resultant filter is highly linear due to the symmetry (around the “main tap”) of the tap-weight structure illustrated in FIG. 8B. Given a sample rate of F_{S}=48 KHz, this filter will exhibit a latency of only about 1.04 ms. The design methods just described may allow for shorter latency times. However, further reducing latency can cause increasing deviation from the design points and indicates a design trade-off between the accuracy of the compensation filter versus filter length. As a further example, FIG. 8E illustrates a comparison for the effects of setting the number of taps at Nₜ=100 taps (1.04 ms latency) versus Nₜ=50 taps (with 0.502 ms latency). In general, an assortment of window functions may prove useful in the design. An advantage of the rectangular window (used for the examples) is that it typically gives better approximation for the design points. Other popular options for windowing include the Hamming, Boxcar, Hann, Bartlett, Blackman and Kaiser window functions, each having their own advantages. Advanced embodiments are envisioned where users may be allowed to select between differing window functions and/or latency settings for the design of the compensation filter based on their preference. Furthermore, it should be emphasized that embodiments for the compensation filter are by no means limited to an FIR filter-based design, as described above. FIG. 9 provides a compensation filter construction that is based on a series of parallel digital filters 801 that collectively comprise the compensation filter 210 of FIG. 3B. In this arrangement, each band-pass filter (or “filter stage” 801) provides a digital filter having close to a 0 dB gain for a desired frequency point from Table 2.0, while attenuation signal components further from this frequency point. By setting the corresponding “gain stage” 802 to match a desired gain as derived from the audiogram database (217 in FIG. 3B) (or in the previous example from Table 2.0), an overall response may be constructed to closely approximate the desired compensation filter data (such as shown in FIG. 7). In this case, each filter stage may be based on an FIR or IIR design to improve cycle efficiency and minimize latency. The assignee of this application has developed a product, referred to as “Noise Assist” that contains a (Cosine modulated) filter bank that for some embodiments may provide a suitable approach for such a filter bank design.

As described earlier, this invention includes provisions for a fully integrated haptic metronome. FIG. 10 shows an example apparatus that could be used for a linear haptic actuator 304D as included in FIG. 2A. The haptic transducer of FIG. 10 may operate by mounting a mass 903 position around a shaft 901 such that linear movement of the mass is permitted along the axis of the shaft 901. This movement may be actuated by applying a voltage across an electric coil 906 placed in proximity to the mass 903, such that when a current exists in the winding of the coil 906, the resultant magnetic field interacts with the material comprising the mass 903. If the mass 903 is constructed of a magnetic material (such as iron), the magnetic field produced by the coil 906 will impart a force onto the mass 903, causing it to move along the shaft 901. In some embodiments, it may be preferable that the mass 903 is a magnet itself. In this case, depending on the polarity of current flowing through the coil, 906, the resultant force may be either an attractive or repellent force between the mass-coil pair (903-906). In general, the resonant frequency for a mass (having mass, m) connected to a linear spring (having spring constant, k) is given by

$$f = \frac{1}{2 π} \sqrt{\frac{k}{m}} .$$

In many embodiments, it may be preferable to drive the haptic interface at a frequency that is below the threshold of hearing (usually 15 to 20 Hz). In these cases, the transducer amplifier 303C dedicated to the haptic acoustic element may be driven at a slower (inaudible) frequency. Alternatively, the transducer amplifier may supply voltage such that a smoothed step function occurs for the current flowing through the coil 906. If this is synchronized to the “beat frequency” for a metronome, the user wearing the device may perceive only a silent “thumping” sensation to provide cues in regard to the metronome timing. To avoid any residual ringing after the conclusion of each pulse due to the resonance of the spring mass (903, 906) combination, it may be advantage for some embodiments to enclose the entire apparatus 900 in a sealed enclosure 907 that is filled with oil or other fluid to provide an appropriate level of damping. One advantage of the enclosure 907 is that this actuator may be constructed as a module, designed to (optionally) be snapped into place (into a receiving harness) during manufacturing. An exterior set of electrical contacts may be positioned such that they mate with corresponding connectors in communication with the haptic transducer amplifier 303C when the haptic actuator 304D or haptic element 304C is installed. Although this disclosure has thus far focused on a metronome having the feature of being non-audible, in some environments, users may be required to work in the presence of exceedingly high noise and vibration levels. In other words, when working in a live performance, musicians can experience a virtual “jungle” of noise and vibration that may mask both subtle sounds and vibrations alike, rendering them imperceptible. In these events, it may become desirable to provide a tactile metronome vibration that overlaps the audible range of human hearing while using relatively high vibrational amplitudes.

Although this disclosure has disclosed exemplary embodiments of implementing the invention, alternative configurations are contemplated within the spirit of the invention. For example, each of the “gain stages” of FIG. 9 may be replaced with a band dependent limiter 802 that derives settings in accordance with data from the audiogram database (217 in FIG. 2B) such that hearing limits (like those of Table 1.0) are followed.

1. An in-ear monitor system comprising:
an audio base unit configured to output base device data, and multi-channel digital audio data;
an in-ear monitor comprising:
an exterior housing;
a first acoustic transducer and a second acoustic transducer;
an in-ear plug housing that is configured to be placed in the ear canal of the user, said in-ear plug housing having an acoustic output port;
a first acoustic chamber extending from the first acoustic transducer in the exterior housing into the interior housing and a second acoustic chamber extending from the second acoustic transducer in the exterior housing into the in-ear plug housing;
an audio transducer processing unit that receives the base device data, and multi-channel digital audio data and converts the multi-channel digital audio data to multi-channel analog audio data that drives the first and second acoustic transducers; and
a haptic metronome actuator on the in-ear monitor;
wherein the audio transducer processing unit drives the haptic metronome actuator to vibrate in pulses occurring at a synchronized timing defined in the received base device data.

2. The in-ear monitor system of claim 1 wherein the recited in-ear monitor is a right side in-ear monitor, and the system further has a left side in-ear monitor comprising:
a left side exterior housing;
a left side first acoustic transducer and a left side second acoustic transducer;
a left side in-ear plug housing that is configured to be placed in the left ear canal of the user, said left side in-ear housing having a left side acoustic output port;
a left side first acoustic chamber extending from the left side first acoustic transducer in the left side exterior housing into the left side in-ear housing and a left side second acoustic chamber extending from the left side second acoustic transducer in the left side exterior housing into the left side in-ear housing;
a left side audio transducer processing unit that receives the base device data, and multi-channel digital audio data and converts the multi-channel digital audio data to multi-channel analog audio data that drives the left side first and second acoustic transducers; and
a left side haptic metronome actuator on the left side in-ear monitor;
wherein the left side audio transducer processing unit drives the left side haptic metronome actuator to vibrate in pulses occurring at the synchronized timing defined in the received base device data.

3. The in-ear monitor system of claim 1 further comprising:
a connecting cable connecting the in-ear monitor to a port the audio base unit; wherein the base device data and the multi-channel digital audio data are transmitted over the connecting cable.

4. The in-ear monitor system of claim 2 further comprising:
a first connecting cable connecting the right side in-ear monitor to a port the audio base unit, wherein the base device data and the multi-channel digital audio data are transmitted over the first connecting cable; and
a second connecting cable connecting the right side in-ear monitor to the left side in-ear monitor, wherein base device data and multi-channel digital audio data are transmitted over the second connecting cable.

5. The in-ear monitor system of claim 4 wherein the first and the second connecting cables are bidirectional connecting cables, each having an active line and a ground line, and data is transmitted bidirectionally over the active lines as time-division multiplexed serial data words.

6. The in-ear monitor system as recited in claim 5 wherein the left-side audio transducer processing unit and the right-side audio transducer unit each comprise:
a. an internal digital processor that de-multiplexes the multi-channel digital audio data and the base device data transmitted to the audio transducer processing unit and outputs separate digital audio signals for each acoustic transducer on the respective in-ear monitor and a digital actuation signal for the haptic actuator on the respective in-ear monitor;
b. multiple digital to analog converters for the acoustic transducers, each receiving one of the separate digital audio signals and outputting an analog audio signal for each acoustic transducer on the respective in-ear monitor; and
c. a digital to analog converter for the haptic actuator that receives the digital actuation signal for the haptic actuator and outputs an analog actuation signal for haptic actuator on the respective in-ear monitor.

7. The in-ear monitor system as recited in claim 2 wherein each in-ear monitor further comprises a microphone in or adjacent the acoustic output port and situated to detect the user's voice through the user's respective ear canal, a transducer amplifier that receives the signal from the microphone, and an analog-to-digital converter in the transducer processing unit, wherein each audio transducer processing unit is configured to also output digital transducer data that is transmitted over the active lines of the bidirectional cables as time-division multiplexed serial data words; and wherein the user is able to operate the haptic metronomes by voice commands.

8. The in-ear monitor system as recited in claim 2 wherein the audio base unit has an RF receiver or transceiver to receive digital audio data and metronome data wirelessly from an RF transmitter of a control console.

9. The in-ear monitor system as recited in claim 8 wherein the system comprises multiple in-ear monitors and audio base units, and the audio base units each have an RF receiver or transceiver to receive digital audio data and metronome data wirelessly from the RF transmitter of the control console.

10. The in-ear monitor system as recited in claim 9 wherein a beat sensor communicates one of the audio base units which in turn transmits beat data to the control console.

11. The in-ear monitor system as recited in claim 1 wherein the haptic actuator has an electric coil that moves a magnetic mass when activated to cause pulse vibrations.

12. The in-ear monitor system as recited in claim 1 wherein the haptic actuator includes a housing containing the moving components of the haptic actuator, said housing being filled with liquid.

13. The in-ear monitor system as recited in claim 1 wherein the haptic metronome actuator is mounted on the exterior housing of the in-ear monitor and is positioned such that when activated the haptic metronome actuator vibrates the in-ear plug housing.
